(19) United States
(12) Patent Application Publication
(10) Pub. No.: US 2023/0097338 A1
(43) Pub. Date: Mar. 30, 2023

(54) GENERATING SYNTHESIZED SPEECH INPUT

(71) Applicant: GOOGLE LLC, Mountain View, CA (US)

(72) Inventors: Nnamdi Kalu, Los Angeles, CA (US); Fernando Fernandes, Mountain View, CA (US); Uri First, Sunnyvale, CA (US); Erwin Jansen, San Mateo, CA (US); Rakesh Iyer, Santa Clara, CA (US); Lingfeng Yang, Mountain View, CA (US)

(21) Appl. No.: 17/533,401

(22) Filed: Nov. 23, 2021

Related U.S. Application Data
(60) Provisional application No. 63/249,346, filed on Sep. 28, 2021.

(51) Int. Cl. G10L 13/08; G10L 13/02; G10L 15/26; G06F 40/279

(52) U.S. Cl. CPC G10L 13/08; G10L 13/02; G10L 15/26; G06F 40/279

(57) ABSTRACT

Systems and methods for synthesizing speech based on received text and one or more emulated speech parameters. Text is received with one or more emulated speech parameters that indicate one or more features for the synthesized speech. Synthesized speech audio is generated based on the received parameters. The synthesized speech audio data is provided to an emulated microphone component that provides the synthesized audio to an automatic speech recognizer. The automatic speech recognizer utilizes one or more speech recognition models to generate converted text based on the synthesized speech audio data.

### BACKGROUND

Application development can be performed utilizing one or more emulators that allow for the application developer to develop the application as if the application, when tested, is executing on a device that is intended for the application. For example, an application developer can execute a test version of an application on an emulator that emulates a mobile device, such as a smartphone. The emulator can include programmatic emulations of hardware and software that mimic the behavior of the emulated device. This may include, for example, hardware components, such as microphone component(s), operating system(s) that may execute on the device, and/or other components that allow for the developer to execute an application for testing purposes. By utilizing an emulator in lieu of the actual client device, the developer can test the behavior of an application as if it were executing on the actual client device. Thus, the developer can test an application's execution behavior on a variety of devices without requiring the developer to possess each device for testing purposes.

Oftentimes, an application developer may require speech as input to an application that is in development. However, for various reasons, it may be infeasible for the developer to provide the speech as audio data. For example, the developer may be located in an environment that is noisy where providing audio captured via a microphone is not practical. Also, for example, the developer may be interested in the performance of one or more applications when audio data is received that is in a language other than a language that is known by the developer. Further, the developer may be interested in testing an application using more than one voice as input (e.g., different genders, accents, speech rates).

### SUMMARY

Techniques are described herein for generating synthesized speech from text and processing the synthesized speech. For example, various techniques described herein are directed to receiving text and one or more parameters, generating synthesized speech based on the text and the parameters, and providing the speech to an emulated microphone component for processing as speech input. In response, the speech is converted to text and processed to cause one or more actions to be performed. By providing input as synthesized speech as opposed to providing the emulator with textual input, automatic speech recognition (ASR) is performed before the input is processed. Conversely, if textual input were to be provided to the emulator, any ASR that is performed by the emulated device would not be utilized. Thus, providing synthesized speech allows for ASR output to be utilized by an application executing on the emulator, ensuring that the application is receiving textual representations of received speech and not merely text that was inputted by the developer.

As an example, an automated assistant application can be tested utilizing an emulator. The developer can input text of “Set an alarm for 3 o'clock.” Typically, this can be processed by the automated assistant as if it were output from an ASR component. However, because the ASR component was not utilized to generate the text, it is unknown if the text that was provided would be the same as what would be generated by the ASR component. Instead, the developer can input the text of “Set an alarm for 3 o'clock” which is then converted into synthesized speech utilizing a text-to-speech model, and provided to the emulated microphone. ASR can then be performed on the synthesized speech and the output from the ASR component can be provided to the automated assistant application. In some instances, the outputted text may vary from the originally inputted text. For example, inputted text can be “set an alarm for 3 o'clock,” which is converted to synthesized speech. When the synthesized speech is provided to the ASR component, the outputted text may be “set an alarm to three oh clock,” differing from the inputted text. This may be interpreted by the automated assistant application differently than the original text and the different interpretation may not be otherwise identified if the text were provided directly. As a result, the application may behave differently for the two different texts, which would be of interest to an application developer. Thus, an application developer can identify differences in ASR output from two different ASR components and improve the robustness of an application in development. For example, a developer can identify that the output from some ASR components is “set an alarm for three oh clock” and other ASR components is “set an alarm for 3 o'clock” and design an application that can handle both possible results.

In some implementations, the text and the emulated speech parameters can be received in response to user interaction with an emulator. For example, the user may be interacting with an emulator that, via software, emulates the behavior of a device such that an application executing via the emulator executes in the same manner as it would if executing on the actual device. This may include, for example, an emulator of a computing device that allows the user to provide additional software and determine the executing behavior of the provided additional software when executed on the emulated computing device. The emulator can include one or more software components that, when executed in conjunction with additional software, emulate the hardware behavior of the computing device that is being emulated. For example, software may be executed by a computing device that is emulating the hardware behavior, via emulation software, of another computing device such that the software that is being executed exhibits the behavior of the emulated computing device.

As an example, a desktop computing device may be executing emulation software that emulates a second device, such as an automated assistant device. The automated assistant device may include a speaker, a microphone, memory, a processor, and/or other hardware components. Each of the hardware components can have a corresponding emulation component that models the behavior of the corresponding hardware component. For example, the emulation software may have a speaker emulation component that can output emulated speech output. Also, for example, the emulation software may have a microphone emulation component that can receive, as input, speech and process the speech in the same manner that the automated assistant would process the speech input.

In some implementations, synthesized speech audio data can be generated based on the received text and emulated speech parameters. For example, the computing device that is executing the emulator may include a text-to-speech component that can receive textual data (e.g., a sequence of phonemes corresponding to text) and output speech data, such as pulse code modulation data. In those instances, the text-to-speech component may be a component of the emulator and/or can be executing independently of the emulator. Also, for example, the text can be transmitted to a remote computing device that includes a text-to-speech component, whereby the text can be converted to speech for further processing, either remotely or by the emulator once transmitted back to the computing device that is executing the emulator.

In some implementations, the text may be provided to a text-to-speech component along with one or more emulator speech parameters. The parameters can include, for example, a gender of the intended voice of the outputted speech, speech rate, language of the speech (either the language of the provided text and/or an indication of a translation to be performed on the text and then converted to speech output), and/or one or more other parameters that indicate prosodic features. Thus, the synthesized speech can be customized to various requirements, such as for testing purposes when provided to a microphone and/or emulated microphone component. As an example, an application may perform in one manner when an English speaker's input is provided to the application, but may perform in another manner when Spanish, or Spanish input that is translated to English, is provided to the application.

In some implementations, the synthesized speech audio data can be provided to the emulated microphone component of the emulator. As previously mentioned, the speech synthesis can be performed by a computing device other than the client device that is executing the emulator. For example, in instances where the speech synthesis is performed by a cloud-based computing device, providing the synthesized speech audio data can include utilizing one or more communication protocols, such as the internet, LAN, and/or other communication channels.

In response to providing the audio data to the emulated microphone component, the synthesized speech audio data can be converted into converted text using one or more speech-to-text models. For example, the emulator, in addition to having an emulated microphone component, can include a speech-to-text component that can receive audio data that includes speech (e.g., from a human and/or as synthesized speech) and converts the speech to text utilizing one or more automatic speech recognition (ASR) models. In some implementations, the speech-to-text conversion can occur on the client device that is executing the emulator. In some implementations, speech-to-text conversion can occur on a separate computing device. For example, a device that is being emulated may not have a speech-to-text component, and received audio data may be transmitted to the same remote computing device that would be utilized by the actual device (e.g., the non-emulated device). In some implementations, ASR can be performed in tandem with remote ASR. In some implementations, ASR can be performed partially via the emulator (and/or the device executing the emulator) and partially remotely by another computing device that has a speech-to-text component.

As an example, a first emulator may utilize a first ASR model to generate converted text from synthesized speech, and a second emulator may utilize a second ASR model to generate converted speech from synthesized speech. The developer can test a plurality of phrases utilizing both emulators and identify instances where the application being tested differs in its behavior. For example, a first emulator may process synthesized speech of “set an alarm for 3 o'clock” as “set an alarm for three oh clock,” whereas a second emulator may process the same synthesized speech as “set an alarm for 3 o'clock.” In instances where the ASR output varies, the developer can update the application in development to handle both phrases, prohibit the application from executing on devices that cannot handle the corresponding ASR output, and/or other actions that reduce likelihood of application issues once the application is deployed to the various devices.

Once the converted text has been provided to the emulated microphone component, one or more actions can be performed by the emulator based on the converted text. Actions can include, for example, verifying the accuracy of the speech-to-text model based on similarity between the converted text and the originally received text, causing one or more applications executing via the emulator to perform one or more actions, and/or one or more other actions that can be performed by the computing device that is being emulated in response to receiving audio data that has been converted to text.

### BRIEF DESCRIPTION OF THE DRAWINGS

FIG. 1 is an illustration of an example environment in which implementations disclosed herein can be implemented.

FIG. 2 depicts components of an emulator in which implementations disclosed herein can be implemented.

FIG. 3 depicts a flowchart of textual input from a user to an application executing via an emulator.

FIG. 4 depicts a flowchart illustrating an example method according to various implementations disclosed herein.

FIG. 5 illustrates an example architecture of a computing device.

### DETAILED DESCRIPTION

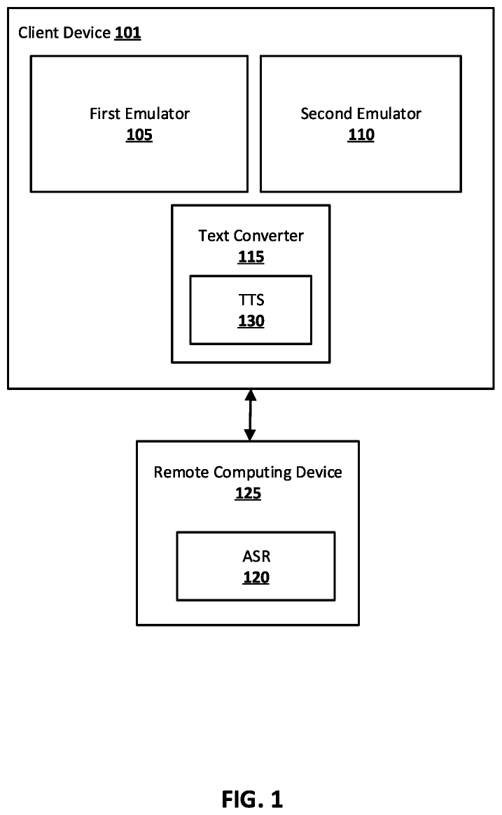

Referring to FIG. 1, an illustration of an example environment in which implementations disclosed herein can be implemented. The example environment includes a client device 101 that is executing a first emulator 105 and a second emulator 110. In some implementations, client device 101 can be executing more or fewer emulators, each of which can emulate the behavior of a different computing device. Further, the client device 101 includes a text converter component 115 that can receive textual input from a developer and provide synthesized speech as output. The environment further includes an automatic speech recognition (ASR) component 120 that is executing on a remote computing device 125. The ASR component can receive audio data that includes speech as input and provide, in response to receiving the audio data, text that represents the speech included with the audio data. In some implementations, the ASR component 120 can be executing on the client device 101. In some implementations, and as described in greater detail below, first emulator 105 and/or second emulator 110 can each have an ASR component that performs some or all speech recognition that is required for the corresponding emulator.

In some implementations, all or a portion of the text converter 115 can be executing on a remote computing device, either remote computing device 125 or a second remote computing device. For example, client device 125 can include a local component that receives textual data and provides the textual data to a text converter that is executing on another computing device. The text converter includes a text-to-speech (TTS) component 130 that can receive text and one or more parameters and generate synthesized speech in response to receiving the text and parameters. In some implementations, all or a portion of the text converter 115 can execute remotely. For example, a local component of text converter 115 can be executing on the client device and receive text and parameters. The local component can transmit the parameters and text to a remote computing device, which then can convert the text to synthesized speech based on the provided parameters. The synthesized speech can subsequently be provided to the local component for utilization by first emulator 105 and/or second emulator 110, or provided directly to one or more emulators.

As previously mentioned, first emulator 105 and second emulator 110 can each be emulating different computing devices. For example, first emulator 105 can be an application that, via software, emulates the hardware behavior of Device A. Second emulator 110 can be an application that, via software, emulates the hardware behavior of Device B, which can have different hardware components (e.g., processor, microphone, speaker, GUI) and/or software components (e.g., operating system) from Device A. A developer can execute an application utilizing first emulator 105 and determine the behavior of the application as if it were executing on Device A with its specifications. Subsequently, the developer can execute the application utilizing second emulator 110 and determine the behavior of the application as if it were executing on Device B with its specifications. Thus, the developer can test the execution of an application on various devices without requiring the developer to install and execute the application on the separate devices.

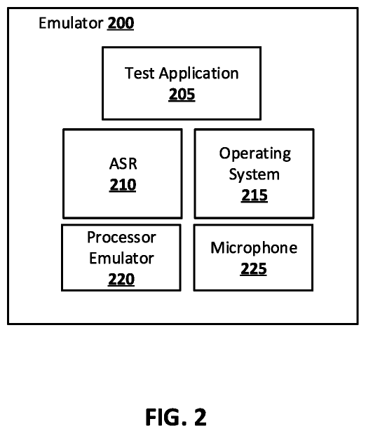

Referring to FIG. 2, a diagram is provided that include components of an emulator in which implementations disclosed herein can be implemented. First emulator 105 and/or second emulator 110 can share one or more characteristics with emulator 200. Further, one or more components of emulator 200 can be shared by multiple emulators. For example, each of first emulator 105 and second emulator 110 may include its own ASR component and/or the same ASR component can be shared by multiple emulators that are executing on the same client device 101.

Emulator 200 includes a processor emulator 220 that models the behavior of the device that is being emulated. For example, processor emulator 220 can be an application that, utilizing a hardware description language, models the processor behavior of the device that is being emulated. Thus, utilization of the emulator 200 allows for a developer to test an application 205 and how the application would behave on the emulated device with the hardware specifications of the emulated device. Further, emulator 200 includes an operating system 215 that, in a manner similar to test application 205, can be executed, in conjunction with processor emulator 220, such that its behavior is similar to that of the operating system executing on the emulated device and the actual processor of the emulated device.

Additionally, emulator 200 includes an emulated microphone component 225. The emulated microphone 225 can receive, as input, audio data as if the component were an actual microphone. For example, emulated microphone 225 can receive pulse code modulation (PCM) audio data that has been captured by another microphone and/or that has been synthesized by one or more other applications, such as text converter 115. Also, for example, emulated microphone 225 can receive audio data in one or more other formats, such as mp4 and/or way audio data. Received audio data can be provided to an ASR component, such as ASR 210 or an ASR component executing separately by the client device 101 or a remote computing device 125). ASR component 210 can be an application that receives audio data, recognizes speech included in the audio data, and provides a textual representation of the speech.

A user (e.g., application and/or hardware developer) can provide text and one or more emulated speech parameters to text converter 115. The parameters can include one or more specifications of prosodic features that are desired for synthesized speech output. Prosodic features can include, for example, speech patterns, intonation, speech rate, speech rhythm, and/or other features that describe the manner in which a human speaker speaks. In some implementations, parameters can include other features, such as gender of the speaker, accent, language, and/or other features of spoken language or the speaker.

As an example, a developer can provide text converter 115 with text of “Set an alarm for 3 o'clock” to text converter 115 along with parameters of “male speaker,” “English,” and a numerical value for a speech rate parameter. Text converter 115 can utilize TTS 130 to generate synthesized speech that conforms to the provided parameters. In response to being provided with the text and parameters, text converter 115 can provide the resulting audio data to one or more components, such as emulated microphone component 225.

In some implementations, text converter 115 can additionally have a translation component and/or can utilize a translation component executing on one or more computing devices. In instances where the emulated speech parameters include a language parameter, the text converter can first translate the text into the desired language before utilizing the TTS component 120 to generate the audio data. Thus, a developer can test the execution of an application when speakers of various languages provide audio input, regardless of whether the developer can speak and/or write the language of the synthesized speech.

As previously described, emulated microphone component 225 can provide received audio data to an ASR component for processing of the audio data into text. In some implementations, the ASR component may be a component of the emulator 200, as illustrated in FIG. 2. In some implementations, the ASR may be performed by an ASR component that is executing on the client device 101. In some implementations, the ASR may be performed by a component of another computing device, as illustrated in FIG. 1. In some implementations, ASR may be performed all or in part by components on both the client device and other computing devices.

The computing device where the ASR is performed can be based, at least in part, on the configuration of the device that is being emulated by emulator 200. For example, for some devices, all or part of ASR may be performed on the device, which can result in an ASR component that is a part of the emulator 200. For some devices, ASR may be performed on a different device in communication with the device. For example, for a given device, received audio data may be transmitted to a cloud-based computing device, which can process the audio data and provide a textual representation. In those instances, ASR can be performed by a device and/or component other than the emulator 200 to model the device behavior. Thus, the same ASR component can be utilized by the emulator 200 as would be utilized by the emulated device, and/or a component that emulates the behavior of the ASR component may be utilized to perform the ASR.

The output of the ASR component 210 (and/or ASR component 120) is provided to a test application 205 for processing. The outputted text may be the same as the inputted text or can vary, depending on the ASR that was performed on the intermediate audio data. For example, for an input text of “Set an alarm for 3 o'clock,” the text and emulated speech parameters can be provided to the text converter 125, which can perform text-to-speech conversion utilizing a TTS component 130, and the resulting audio data can be provided to the microphone component 225, which then can provide the audio data to an ASR component. Once processed by the ASR component, a resulting text of “set an alarm for three oh clock” may be provided to the test application by the ASR component.

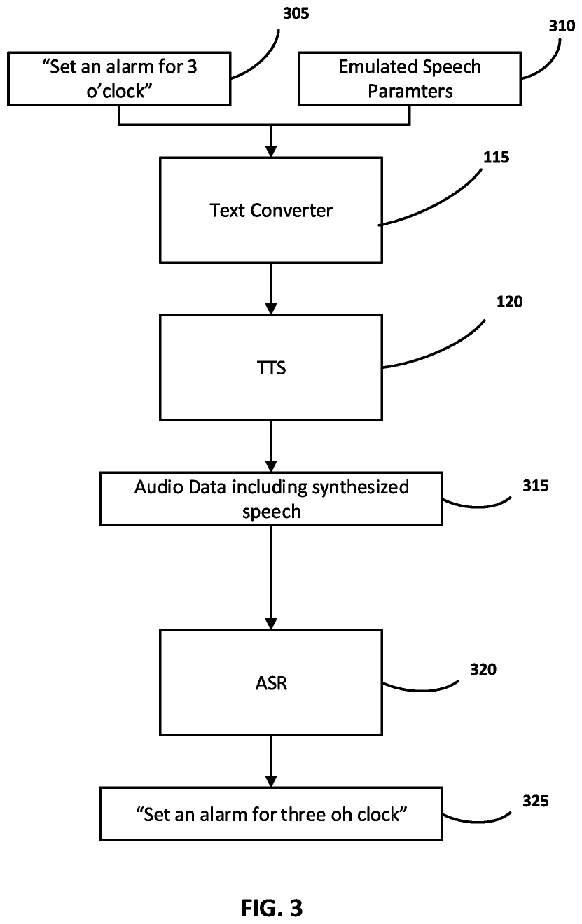

Referring to FIG. 3, a flowchart is provided that illustrates text that is provided to a text converter and provided to an application. Text 305 of “Set an alarm for 3 o'clock” and emulated speech parameters 310 can be provided, in text form, to text converter 125. Text converter utilizes TTS component 130 to generate audio data 315, which includes emulated speech that corresponds to the text 305 with the characteristics described by parameters 310. The audio data is provided to ASR component 320, which performs ASR on the audio data and generates a textual representation 325 of “set an alarm for three oh clock.” Thus, in this instance, the final textual representation of the original text, generated from an intermediate audio representation of the text, is not identical to the original text.

In some implementations, the developer may recognize that one or more common terms that may be included in speech provided to the application in development are not being converted to text as expected. For example, the developer may be developing a restaurant reservation application and the term “Laotian” is commonly used by users of the application to select a cuisine type. The developer may determine that one or more ASR models converts the spoken utterance of “Laotian” as “le ocean,” which may cause issues with the application. Thus, by comparing the original text to the ASR output, the developer can identify potential phrases to bias when received by the application such that, when ASR output is “le ocean,” the application can process the converted text as “Laotian.”

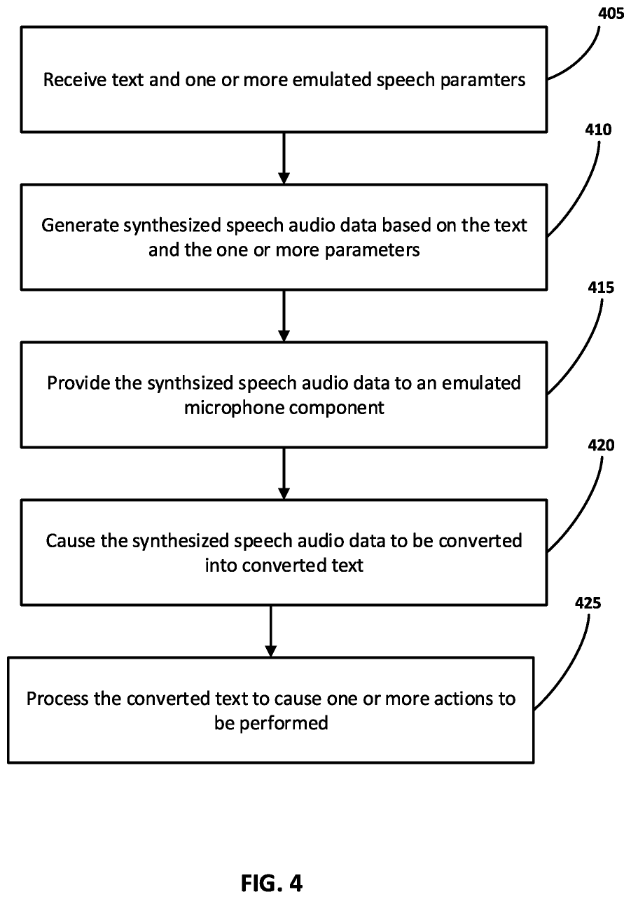

FIG. 4 depicts a flowchart illustrating an example method of generating synthesized speech from text and processing the synthesized speech to generate converted text. For convenience, the operations of the method are described with reference to a system that performs the operations. This system of method includes one or more processors and/or other component(s) of a client device. Moreover, while operations of the method are shown in a particular order, this is not meant to be limiting. One or more operations may be reordered, omitted, or added.

At step 405, text and one or more speech synthesis parameters are received. The text can be received by a component that shares one or more characteristics with text converter 115 of FIG. 1. For example, the text can be provided to a TTS component that takes text and one or more parameters as input and generates synthesized speech that conforms to the parameters. Emulated speech parameters can include, for example, speech rate, gender of the speaker, language of the text, accent, and/or other properties of speech. In some implementations, the text is provided via an emulator interface. For example, the text converter 115 and/or one or more other components that generate synthesized speech can be a component of an application that is emulating the behavior of another device, such as first emulator 105 and/or second emulator 110 of FIG. 1. In some implementations, the text conversion can be performed by a separate application that is executing, at least in part, on the same client device as an emulator, as illustrated in FIG. 1.

At step 410, synthesized speech audio data is generated based on the text and the one or more speech synthesis parameters. The synthesized speech can be generated such that it has one or more characteristics that are described by the provided emulated speech parameters. For example, the synthesized speech can be generated to have a particular speech rate, be a translation of the received text into another language, and/or other features of speech that can be synthesized by a text converter, as described with reference to text converter 115. The resulting synthesized audio data can be, for example, pulse code modulation audio data and/or other audio data that includes synthesized speech that corresponds to the received text and has the properties described by the emulated speech parameters.

At step 415, the synthesized speech audio data is provided to an emulated microphone component of an emulator interface. The emulated microphone component can share one or more characteristics of microphone component 225 of FIG. 2. For example, the emulated microphone component can receive, as input, audio data that can be provided to one or more other components as if the audio data were captured by the microphone that is being emulated.

At step 420, the synthesized speech audio data is converted to converted text. The conversion can be performed by an ASR component, such as ASR component 120 of FIG. 1 and/or ASR component 210 of FIG. 2. For example, in some implementations, ASR can be performed by a component of an emulator in instances where the emulated device performed at least a portion of ASR on the device. In some implementations, ASR can be performed by a component that is executing on the device that is executing the emulator. For example, to emulate ASR being performed on a device other than the emulated device, the emulator can provide the audio data to an ASR component that is separate from the emulator but executing on the same device as the emulator. In some implementations, ASR can be performed by one or more components of another device. This can be, for example, the same ASR component that would perform ASR for the emulated device.

At step 425, the converted text is processed, causing one or more actions to be performed. For example, the emulator can be executing an application (e.g., an automated assistant application) that is being tested, and the converted text can be provided to the test application as input. The application can then process the converted text and perform one or more actions. In some implementations, the one or more actions can include verifying the similarity between the original text and the converted text. For example, for an original text of “Set an alarm for 3 o'clock,” a converted text of “set an alarm for three oh clock” can be compared to the original text to determine how similar the two texts are to each other. This can include, for example, similarity of grammar, spelling, accuracy of language translations, and/or other semantic similarities between the texts.

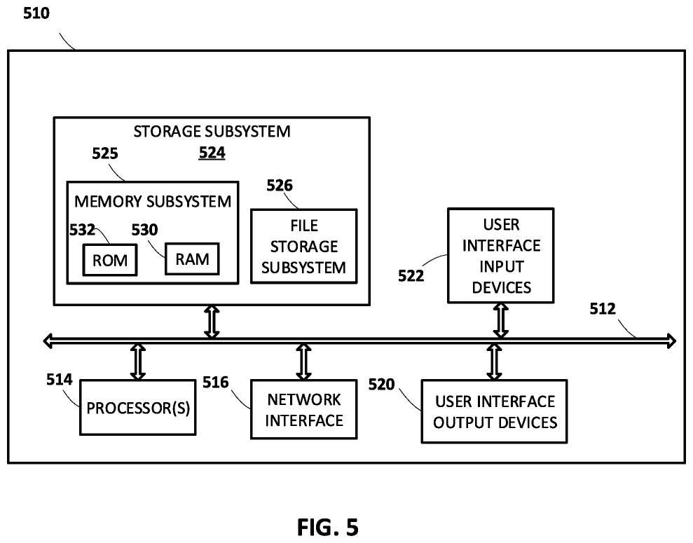

FIG. 5 is a block diagram of an example computing device 510 that may optionally be utilized to perform one or more aspects of techniques described herein. Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods of FIG. 5 and FIG. 6, and/or to implement various components depicted in FIG. 2 and FIG. 3.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In some implementations, a method implemented by one or more processors is provided and includes: receiving, from the client device, text and one or more emulated speech parameters, wherein the text and the one or more emulated speech parameters are received in response to user interaction with an emulation interface of an emulator, the emulator having an emulated microphone component, generating synthesized speech audio data based on the text and the one or more emulated speech parameters, wherein generating the synthesized speech audio data comprises processing the text using a speech synthesis model and based on the one or more emulated speech parameters, and providing the synthesized speech audio data to the emulated microphone component. In response to providing the audio data, the method further includes: causing the synthesized speech audio data to be converted into converted text using a speech-to-text model; and processing the converted text to cause one or more actions to be performed.

These and other implementations of the technology disclosed herein can include one or more of the following features.

In some implementations, the audio data is pulse-code modulation (PCM) audio data.

In some implementations, the one or more emulated speech parameters includes speech rate for the synthesized speech audio data.

In some implementations, the one or more emulated speech parameters includes a language for the synthesized speech audio data. In some of those implementations, the method further includes: translating the text into a second text in the language, wherein generating the audio data includes generating the synthesized speech based on the second text.

In some implementations, the generating of the audio data is performed by a second computing device executing the speech synthesis model.

In some implementations, processing the converted text to cause one or more actions to be performed includes: comparing the converted text to the text; and determining, based on the comparison, an accuracy score indicative of similarity between the converted text and the text.

In some implementations, a system is disclosed that comprises one or more processors and memory storing instructions that, in response to execution of the instructions by the one or more processors, cause the one or more processors to perform the following operations: receiving, from the client device, text and one or more emulated speech parameters, wherein the text and the one or more emulated speech parameters are received in response to user interaction with an emulation interface of an emulator, the emulator having an emulated microphone component, generating synthesized speech audio data based on the text and the one or more emulated speech parameters, wherein generating the synthesized speech audio data comprises processing the text using a speech synthesis model and based on the one or more emulated speech parameters, and providing the synthesized speech audio data to the emulated microphone component. In response to providing the audio data, the instructions further includes: causing the synthesized speech audio data to be converted into converted text using a speech-to-text model; and processing the converted text to cause one or more actions to be performed.

In some implementations, at least one non-transitory computer-readable medium is provided that comprises instructions that, in response to execution of the instructions by one or more processors, cause the one or more processors to perform the following operations: receiving, from the client device, text and one or more emulated speech parameters, wherein the text and the one or more emulated speech parameters are received in response to user interaction with an emulation interface of an emulator, the emulator having an emulated microphone component, generating synthesized speech audio data based on the text and the one or more emulated speech parameters, wherein generating the synthesized speech audio data comprises processing the text using a speech synthesis model and based on the one or more emulated speech parameters, and providing the synthesized speech audio data to the emulated microphone component. In response to providing the audio data, the instructions further includes: causing the synthesized speech audio data to be converted into converted text using a speech-to-text model; and processing the converted text to cause one or more actions to be performed.

In situations in which certain implementations discussed herein may collect or use personal information about users (e.g., user data extracted from other electronic communications, information about a user's social network, a user's location, a user's time, a user's biometric information, and a user's activities and demographic information, relationships between users, etc.), users are provided with one or more opportunities to control whether information is collected, whether the personal information is stored, whether the personal information is used, and how the information is collected about the user, stored and used. That is, the systems and methods discussed herein collect, store and/or use user personal information only upon receiving explicit authorization from the relevant users to do so.

For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method implemented by one or more processors of a client device, the method comprising:
receiving, from the client device, text and one or more emulated speech parameters, wherein the text and the one or more emulated speech parameters are received in response to user interaction with an emulation interface of an emulator, the emulator having an emulated microphone component;
generating synthesized speech audio data based on the text and the one or more emulated speech parameters, wherein generating the synthesized speech audio data comprises processing the text using a speech synthesis model and based on the one or more emulated speech parameters;
providing the synthesized speech audio data to the emulated microphone component; and
in response to providing the audio data:
causing the synthesized speech audio data to be converted into converted text using a speech-to-text model; and
processing the converted text to cause one or more actions to be performed.

2. The method of claim 1, wherein the audio data is pulse-code modulation (PCM) audio data.

3. The method of claim 1, wherein the one or more emulated speech parameters includes speech rate for the synthesized speech audio data.

4. The method of claim 1, wherein the one or more emulated speech parameters includes a language for the synthesized speech audio data.

5. The method of claim 4, further comprising:
translating the text into a second text in the language, wherein generating the audio data includes generating the synthesized speech based on the second text.

6. The method of claim 1, wherein the generating of the audio data is performed by a second computing device executing the speech synthesis model.

7. The method of claim 1, wherein processing the converted text to cause one or more actions to be performed includes:
comparing the converted text to the text; and
determining, based on the comparison, an accuracy score indicative of similarity between the converted text and the text.

8. A system comprising one or more processors and memory storing instructions that, in response to execution of the instructions by the one or more processors, cause the one or more processors to perform the following operations:
receiving, from a client device, text and one or more emulated speech parameters, wherein the text and the one or more emulated speech parameters are received in response to user interaction with an emulation interface of an emulator, the emulator having an emulated microphone component;
generating synthesized speech audio data based on the text and the one or more emulated speech parameters, wherein generating the synthesized speech audio data comprises processing the text using a speech synthesis model and based on the one or more emulated speech parameters;
providing the synthesized speech audio data to the emulated microphone component; and
in response to providing the audio data:
causing the synthesized speech audio data to be converted into converted text using a speech-to-text model; and
processing the converted text to cause one or more actions to be performed.

9. The system of claim 8, wherein the audio data is pulse-code modulation (PCM) audio data.

10. The system of claim 8, wherein the one or more emulated speech parameters includes speech rate for the synthesized speech audio data.

11. The system of claim 8, wherein the one or more emulated speech parameters includes a language for the synthesized speech audio data.

12. The system of claim 11, wherein the instructions further cause the one or more processors to perform the following operation:
translating the text into a second text in the language, wherein generating the audio data includes generating the synthesized speech audio data based on the second text.

13. The system of claim 8, wherein the generating of the audio data is performed by a second computing device executing the speech synthesis model.

14. The system of claim 8, wherein the instructions further cause the one or more processors to perform the following operations:
comparing the converted text to the text; and
determining, based on the comparison, an accuracy score indicative of similarity between the converted text and the text.

15. At least one non-transitory computer-readable medium comprising instructions that, in response to execution of the instructions by one or more processors, cause the one or more processors to perform the following operations:
receiving, from a client device, text and one or more emulated speech parameters, wherein the text and the one or more emulated speech parameters are received in response to user interaction with an emulation interface of an emulator, the emulator having an emulated microphone component;
generating synthesized speech audio data based on the text and the one or more emulated speech parameters, wherein generating the synthesized speech audio data comprises processing the text using a speech synthesis model and based on the one or more emulated speech parameters;
providing the synthesized speech audio data to the emulated microphone component; and
in response to providing the audio data:
causing the synthesized speech audio data to be converted into converted text using a speech-to-text model; and
processing the converted text to cause one or more actions to be performed.

16. The at least one non-transitory computer-readable medium of claim 15, wherein the audio data is pulse-code modulation (PCM) audio data.

17. The at least one non-transitory computer-readable medium of claim 15, wherein the one or more emulated speech parameters includes speech rate for the synthesized speech audio data.

18. The at least one non-transitory computer-readable medium of claim 15, wherein the one or more emulated speech parameters includes a language for the synthesized speech audio data.

19. The at least one non-transitory computer-readable medium of claim 15, wherein the generating of the audio data is performed by a second computing device executing the speech synthesis model.

20. The at least one non-transitory computer-readable medium of claim 15, wherein processing the converted text to cause one or more actions to be performed includes:
comparing the converted text to the text; and
determining, based on the comparison, an accuracy score indicative of similarity between the converted text and the text.
